(19) United States
(12) Patent Application Publication
(10) Pub. No.: US 2003/0208416 A1
(43) Pub. Date: Nov. 6, 2003

(54) System and method for recording owner information into an element containing a unique signature, which may be affixed to property of owner for purposes of identifying owner of lost, misplaced or discovered objects

(76) Inventor: Joshua Watters, Ellicott City, MD (US)

Correspondence Address: Josh Watters, 9040 F town and country Blvd, Ellicott City, MD, 21043, US

(21) Appl. No.: 10/138,584

(22) Filed: May 6, 2002

(51) Int. Cl. G06F 17/60

(52) U.S. Cl. 705/28

(57) ABSTRACT

The use of electronic signatures, bar codes or digital serial numbers to link objects and belongings to owner information contained in an electronic database. A small identifier device, which stores or represents a digital signature or serial code, shall be affixed to any object. Through use of this signature a person's, corporation's or entity's information can be retrieved to identify the owner of the object and provide a mechanism for return of that object to the proper owner.

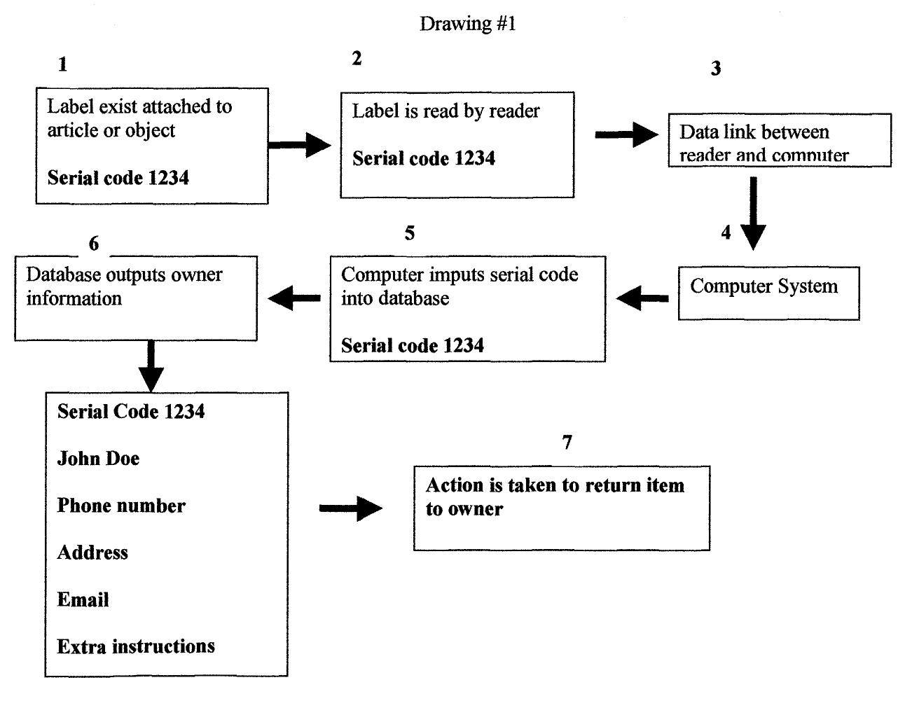

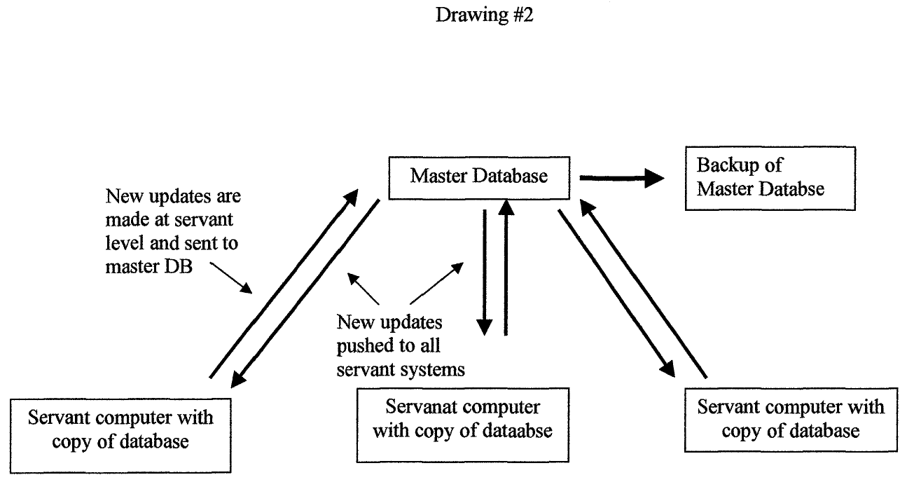

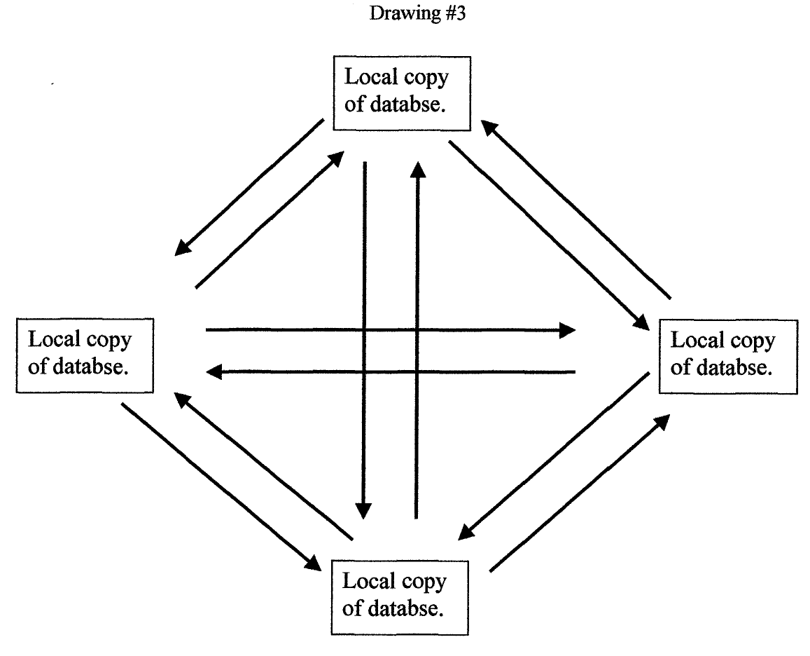

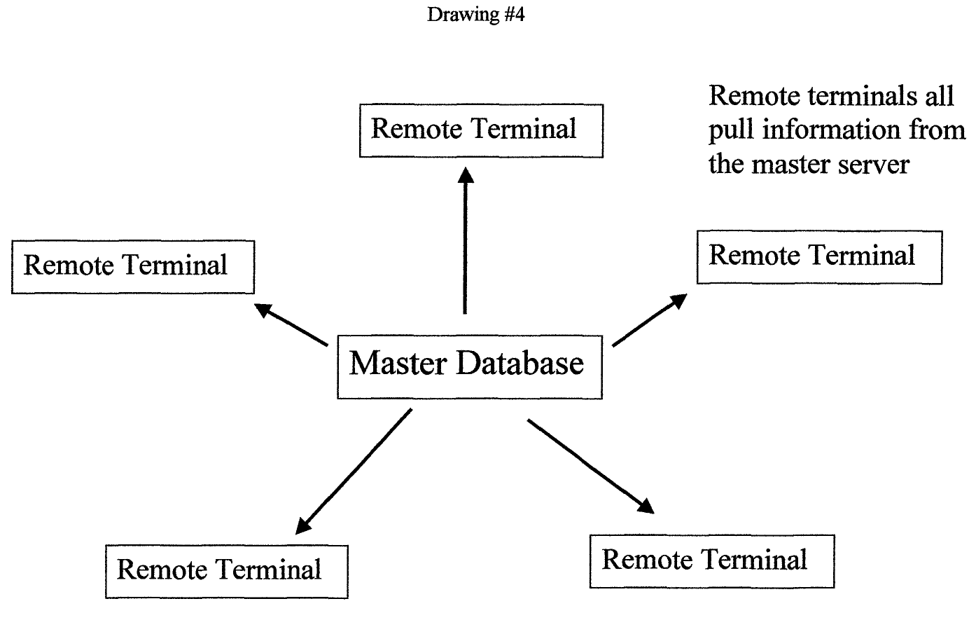

### CROSS-REFERENCE TO RELATED APPLICATIONS

Not Applicable

### FEDERALLY SPONSORED RESEARCH

Not Applicable

### REFERENCE TO SEQUENCE LISTING

Not applicable

### BACKGROUND OF INVENTION

For years people have attached personal information to belongings so that if those belongings are found they can potentially be returned to the owner. This practice is extremely popular in clothing and even more so for the clothing of children visiting away from home. The information is often written onto the label or sowed into a discreet location so that it does not interfere with the appearance of the clothing.

Many belongings, which are frequently lost or misplaced, can not easily be marked by writing. A set of car keys for example has no spot where such writing can be placed or where it can be easily read if such markings are made. Attaching a label to these items can make them larger and more cumbersome to carry. Furthermore attaching a label which provides owner information poses a security risk as these keys may give access to the residence or possessions of the owner.

Current devices are designed such that information can be stored in a small spatial volume such as a microchip, magnetic storage, bar code, or electrical device which can emit a signal used to identify it or otherwise communicate with external technologies. Many of these devices can be used to store information on or into objects where writing or affixing a label to them is undesirable.

Such a device could be attached to a key chain without obtrusion. It could be woven into fabric or attached as a button. The various forms used to record and transmit this information allow for integrated articles to remain discreet or even hidden.

If such a device is integrated or attached to an object, information is contained within the object to provide return to its owner.

Prior Art

A search has been conducted by the applicant prior to the filing of this patent application. The following patents are brought to the attention of the examiner.

U.S. Pat. No. 4,662,091, granted to Foster, discloses a key-like tag with personal and medical information incorporated in a microfiche chip.

U.S. Pat. No. 4,916,679, granted to Agnello, discloses a watch protector with a fabric strap, which incorporates a microwave transponder for location of the wearer when lost.

U.S. Pat. No. 4,271,352, granted to Thomas discloses a tag device which includes the visible address of a central lost item processing location where the tag is read for information on the owner's address by means of a bar code, magnetics, infra-red, embossed character recognition or semiconductor memory.

U.S. Pat. No. 5,180,192, granted to Herbert, describes a system for returning lost keys to their owner. This system uses a bar code to link the key to a physical set of information containing the owner's information. The above system relies on the post office to insure return of the lost items. Herbert references U.S. Pat. No. 4,271,352 in his patent application.

The method employed in U.S. Pat. No. 5,180,192 uses an electronic device to read a bar code, but maintains all vital information on physical cards or microfilm. This requires that any keys be shipped to a central location for identification. The need for physical copies of owner information to be stored at a remote location is a critical drawback to Herbert's invention, which has prevented the adoption of his system.

The need for a single central processing station is another.

U.S. Pat. No. 5,631,631, granted to Deschenes, discloses a tagger for attachment to an article of clothing or other article of commerce which contains a transponder with a chip with various types of information, such as price, inventory information, and whether or not the article has been duly purchased. The scope of this patent is limited to use of transponders at a single location for the purposes of theft prevention. Once an article and its corresponding transponder are removed from the initial monitored location, the transponder is unidentifiable and indistinguishable. The use of Deschenes' invention outside its initial location would constitute an invasion of privacy, as any valuable implementation of invention would by necessity be made without consumer consent.

U.S. Pat. No. 5,722,999, granted to Snell, discloses an implant able medical device and programmer, which incorporates historical and current medical information. The information can be stored in the programmer, the implant able medical device, or both.

U.S. Pat. No. 6,297,727, granted to Nelson, discloses an identification and record assembly, which includes a patch with a transponder, which contains an identification code for the owner. The transponder and data element are created simultaneously and the data element removed when the transponder is attached by means of an adhesive. This device appears specially adapted for use with animals.

The focus of this patent is that the transponder and data element are created simultaneously, i.e. that the data element is affixed to the transponder and not removed until the transponder is affixed to its target.

U.S. Pat. No. 6,317,030, granted to Toubia et al, discloses a system for conducting a hunting tournament using passive transponder identification. Game to be hunted are captured and passive transponders inserted under their skins. Killed animals are scanned and prizes awarded for those with particular transponders. Since the hunter cannot determine if a killed animal is a prize winner, there is no incentive to discard an animal and kill another.

U.S. Pat. No. 6,317,049 discloses an apparatus for locating missing persons, animals and objects which involves a small transponder whose location is determined using Doppler tracking with low-altitude satellites.

None of the discovered prior art publications have the properties of the present invention, that of providing a device containing a unique signature, attached to an article, the device, when scanned, emits a unique identifier which corresponds to a data entry in a database, and which may cause automatic action by the database in notifying the owner of the article. The database may exist in a single location, (with redundant copies as needed for backup) such that scanners worldwide can access the information by means of a computer network, or the database may exist in multiple locations and receive live updates by means of a computer network, or the database may exist in a combination of the two prior forms where one master record is maintained and all slave instances are updated to contain the same records.

### BRIEF DESCRITPION OF THE INVENTION

The present invention provides a method and apparatus for linking owner information to owned articles without the faults or limitations accompanying the prior art system as described in the background of the invention.

The present invention includes a method of implementing and maintaining a computer database which allows for all instances of the database at all locations to be identical, such that all instances contain the same information and that all instances are updated when a change is made to any singular instance.

The present invention includes a manner for storing and retrieving information superior to current practices.

### BRIEF DESCRITPION OF THE DRAWINGS

Drawing one is a flow chart diagram of the actions involved to retrieve owner information and then act on that information.

1) Any article must be affixed with a label or transponder, which has a unique serial number or pattern signature. Information corresponding to the owner of the article is placed into the database at the time the label or transponder is affixed to the article, or information may be recorded into the database before the label or transponder is affixed. Furthermore information may be changed at any later date.

2) If the article is found or discovered by anyone other than the owner, the article may be taken to a vendor who has access to the database. A reader can be used to read the unique serial number or pattern signature attached to the article.

3) A data link exists between the computer and the reader such that the information may be input to the computer. In another embodiment of the invention, the reader could display a serial number and a human operator could input that information into the computer database. In this embodiment, the human operator acts as the data link.

4) A computer system housing the database, or which has access to a remote copy of the database, receives the serial code or pattern signature.

5) Data is sent to the database.

6) The database receives input and outputs the owner information associated with said serial number or pattern signature.

7) Once the owner information has been retrieved, the vendor may take any number of measures to return the item to its rightful owner.

Drawing two is a depiction of the computer network needed to maintain the master slave relationship for database updates.

In this setup, new entries are added at the slave level. At regular intervals, slave systems report new entries to the master server. New entries are made to the database by the master server. These new entries are then “pushed” down to all slave systems. One or more backup copies of the master server are kept in case the master server should fail. In this arrangement slave systems are capable of operating even if contact with the master server is disconnected. However such operation may posses old or outdated information. Furthermore new entries made at the slave level without contact to the master server will not be available to other slave systems.

Drawing three is a depiction of the computer network needed to maintain the peer to peer database network.

In this setup, no master server exists. Changes made to any system are sent out to all other systems on the network. Systems exist as identical copies and serve as their own backup. Certain inefficiencies with this setup make the Master/Slave relationship the preferred embodiment.

Drawing four is a depiction of the computer utilizing a single master database with access from multiple points.

In this setup a master database exist. All slave systems do not house copies of the database. Instead each slave system communicates with the master server. New entries are sent from remote terminals to be added in the master database. When articles are retrieved, slave systems query the master server for owner information. In this arrangement slave systems can not operate without contact to the master server. Certain inefficiencies with this arrangement make the Master/Slave relationship the preferred embodiment.

### DETAILED DESCRIPTION OF THE INVENTION

In all embodiments of the present invention the method of identification requires information transfer between three devices; “identifier”, “receiver”, and “list.”

The identifier shall be defined as the mechanism which transmits, displays or can be made to display a signature unique to that physical device. The identifier may display this signature by means of visual pattern, such as bar code, or it may be induced to transmit an electric or electromagnetic pattern, such as the ibutton manufactured by Dallas Semiconductors.

In the example of a bar code, the code can be read by a scanner, which translates the bar code into a serial number.

Another, more complicated example of an identifier would be an electronic device possessing a unique serial number such as the ibutton from Dallas Semiconductors. The ibutton is hard coded with a unique 64-bit serial number. An electric field can be applied to the metal case of the device. When such a field is applied, the internal circuitry of the device sends back its 64-bit code to the receiver.

The receiver shall be defined as any device capable of receiving or interpreting the pattern from the identifier, or inducing the identifier to transmit or display said pattern. The receiver shall be capable of either presenting that pattern in an understandable form to a human operator or to transmit that information directly to the list.

In the case of a bar code, the receiver would be the laser scanner, which scans the code and translates it into a serial number.

In the case of the ibutton, the DS1402 Blue Dot receptor from Dallas Semiconductors acts as the receiver, this device when placed in physical contact with the ibutton, reads the digital signature and transmits that information to a computer by means of either a serial or parallel port connection.

The list shall consist of an electronic database where digital signatures are stored along with relevant user information. An example of such a database would be access software produced by Microsoft, oracle database, Sybase, sap, power builder, SQL server from Microsoft. Many other database software programs exist. When a unique code is input into this database, the software allows for immediate recovery of user information associated with that code.

There are multiple embodiments and configurations such that an identifier can be read by a receiver and communicate to a database.

Each specific identifier would require appropriate technology in a compatible receiver. There is a direct link between the identifier and the receiver as should be obvious to anyone experienced in the art. There is no such link between the database software and the receiver or the identifier. So long as the receiver is capable of transmitting information to a computer by means of a serial port, parallel port, USB, infrared, LAN connection, RJ45, coax, or other means which may become available as a standard computer protocol, the software remains independent of the embodiment of the receiver and identifier.

In one embodiment of the invention, the receiver could visually display an alphanumeric code to an operator. The operator would then manually enter said code into the database to retrieve relevant information. In this embodiment the computer link between the receiver and the database is substituted with operator interaction.

Process

An identifier is affixed to an object. This identifier possesses a unique signature or serial number.

A database exists which contains all issued serial numbers and ties each serial number to the information of the individual or group which owns the identifier and the object to which the identifier is affixed.

This database may be centralized, such that users from any location can access its information, or it may reside on multiple computers. If the database resides on multiple computers, these computers will be connected in a manner that allows every copy of the database to be updated electronically when new serial numbers are issued. This ability to update remote copies of the list is an important improvement over prior art.

When a lost item is brought to an appropriate vendor, a receiver is used to retrieve the unique serial number from the identifier.

This unique code is input into to the database.

The database outputs stored owner information.

From this information, the vendor is able to return the item by any appropriate means. The item may be mailed to the owner. The owner may be contacted to pick up the item. The vendor may be capable of directly returning the item.

What is claimed:

1) The use of electronic systems comprising
A) an identifier,
B) reader, and
C) list
to link owner information of a particular object or article to said object by means of an affixed or integrated identifier,
which can be interpreted by the reader,
and which references a specific database entry containing owner information.

2) Claim 1 where the identifier is a bar code or other non electrical device representing a serial number or pattern signature which can be read by a nonintegrated device to obtain the unique signature, and where said signature can be used to retrieve owner information from an electronic database.

3) Claim 1 where the identifier is an electronic device, which contains only a serial number or electronic signature, which can be read by a non-integrated device to obtain the unique signature, and where said signature can be used to retrieve owner information from an electronic database.
including a method by which information is transmitted from the identifier by means of an electric, magnetic or electromagnetic field to a receiver.

4) Claim 3 where signals are sent and received by the identifier.

5) Claim 1 where the identifier is an electronic device which contains any or all owner information, comprising both the identifier and list, and said information cannot be retrieved without the use of additional technology (the reader) which is not integrated into the owned object.
Claim 5 resembles claims 2 and 3 and differs only in that the identifier is a self sufficient database entry that must be retrieved by a separate piece of technology.

6) Claim 5 where signals are sent and received by the identifier device.
